(19) United States
(12) Patent Application Publication
(10) Pub. No.: US 2018/0136035 A1
(43) Pub. Date: May 17, 2018

(54) METHOD FOR DETECTING VIBRATIONS OF A DEVICE AND VIBRATION DETECTION SYSTEM

(71) Applicant: Prüftechnik Dieter Busch AG, Ismaning (DE)

(72) Inventor: Roland HOLZL, Munich (DE)

(21) Appl. No.: 15/568,056

(22) PCT Filed: Apr. 14, 2016
(86) PCT No.: PCT/DE2016/100176

§ 371 Date: Oct. 20, 2017

(30) Foreign Application Priority Data
Apr. 20, 2015 (DE) 10 2015 207 134.0

(51) Int. Cl. G01H 1/00; G01H 9/00

(52) U.S. Cl. CPC G01H 1/003; G01H 9/00

(57) ABSTRACT

The invention relates to a vibration monitoring system (17) for detecting vibrations of a device (1), comprising at least one vibration sensor (2, 3, 18) and at least one pair of smart glasses (4, 19) with at least one data processing means (6) and at least one display means (7), wherein a data transmission path (12, 13, 22, 23) can be established between the vibration sensor (2, 3, 18) and the smart glasses (4, 19). In order to detect vibrations of a device (1), at least one vibration sensor (2, 3, 18) of the vibration monitoring system (17) is arranged on the device (1), wherein vibrations of the device (1) are detected by the vibration sensor (2, 3, 18) and measurement data which represent the detected vibrations are transmitted to the smart glasses (4, 19) of the vibration monitoring system (17). The measured data are processed by the data processing means (6) of the smart glasses (4, 19) and a result of the processing is displayed on the display means (5) of the smart glasses (4, 19).

The present invention relates to a method for detecting vibrations of a device and to a vibration detection system and, in particular, to a vibration detection system for carrying out the method for detecting vibrations of a device.

In many devices such as machines or wind power plants, vibrations occur during operation and, over the course of time, may prove to be disruptive or even harmful not only for the operation of the device but also for the device itself. It is therefore necessary to monitor the vibrations which occur. For this purpose, it is known practice to arrange vibration sensors on devices, which sensors detect vibrations of the devices. Measurement data representing the detected vibrations can be buffered and can be read at a later time by means of a reading unit or may be transmitted in real time to a unit for their evaluation.

A method for monitoring vibrations of rotating machines is disclosed, for example, in DE 10 2012 015 485 A1.

DE 102 04 043 C1 discloses a system and a method for detecting and evaluating mechanical vibration signals, which make it possible to contactlessly detect and automatically evaluate the mechanical vibration signals. The system has a measuring laser for contactlessly detecting mechanical vibration signals and data glasses for representing results of the assessment of the vibration signals.

WO 03/050626 A1 discloses the use of a system having data glasses for creating documentation of operations for presentation in an augmented reality system. The system has, in particular, tracking means for determining the position and orientation of a camera relative to points in the room and a mobile computer for processing the image information recorded by the camera and the position and orientation of the camera and for forwarding the processed image information as image data and the position and orientation of the camera as tracking information to a remote computer system. WO 00/58799 A1 also discloses a comparable system for processing documentation, in particular for technical and industrial applications.

In contrast, EP 2 523 061 A1 discloses a monitoring system which has data glasses and is provided for the purpose of monitoring machines. The data glasses have a sensor for detecting the presence of an installation within a predefined distance from the data glasses.

Against this background, the object of the present invention is to provide a method and a vibration monitoring system which simplify the monitoring of devices.

This object is achieved by means of the method having the features of claim 1 and by means of the vibration monitoring system having the features of claim 8. The dependent claims relate to preferred embodiments.

In the subject matter of the present application, data glasses are advantageously provided when detecting vibrations of a device, which simplifies the monitoring of the device. In contrast to the conventional monitoring of vibrations of devices, in which values recorded by vibration sensors are transmitted to a portable handheld unit and are evaluated or displayed on the latter, the present invention makes it possible to completely dispense with such a handheld unit. Instead of transmitting the measured values to a handheld unit, the measured values are transmitted in the subject matter of the present invention to the data glasses in order to be processed there by the data processing means of the latter which may have at least one processor or which may be a miniature computer or minicomputer. Results generated from the processing of the measured values, in which case the processing may be, in particular, a simple comparison of the measured values with one or more predefined values, are then displayed on the display means of the data glasses. Since a conventional handheld unit usually weighs approximately 1 kg and has to be manually held during its operation or during the monitoring of the device and in practice also has to be put down and newly picked up again and again, with the result that a user, for example a maintenance person, easily loses sight of a display of the unit which can display important information for the current operation, a method which can be carried out without a handheld unit contributes significantly to simplifying the detection and monitoring of vibrations of a device. The present invention therefore allows not only ergonomic monitoring of devices, but also more cost-effective monitoring of devices as a result of the elimination of the handheld unit. In addition, the practice of displaying the result of the processing of the measurement data in the display means of the data glasses, like in the present invention, entails the advantage, in comparison with displaying it in a display of a handheld unit, that this information is always visible to a user of the data glasses, for example a maintenance person, even during different activities, with the result that the user can comfortably and effectively carry out his tasks. In this case, notifications, warnings and alarms can be output to the user or the maintenance person optically via the display means or acoustically if the vibration monitoring system and, in particular, the data glasses have a loudspeaker. In this case, feedback from the user or the maintenance person can be provided in any desired manner, for example by voice input, contact or touch, blinking and eye or head movements.

The display means may be a so-called head-up display (HUD), that is to say a display system in which the wearer of the data glasses can maintain the position of his head or his viewing direction because information is projected into his field of view. If necessary, the data glasses may have further apparatuses, for example at least one data memory and/or at least one spatial angle measuring means and/or at least one acceleration sensor and/or at least one nine-axis sensor and/or at least one gyroscope and/or at least one inclinometer and/or at least one compass and/or at least one touchpad and/or at least one bone-conduction loudspeaker and/or at least one interface, which can be used to establish a connection to a local area network and/or to the Internet and/or to a navigation system, and/or at least one USB (Universal Serial Bus) connection and/or at least one current source and/or at least one battery and/or at least one rechargeable battery and/or at least one touch-sensitive point, and/or the data glasses are set up to manually modify or operate graphically or holographically displayed elements, and/or the data glasses can be at least partially controlled by means of blinks.

A current source in the form of a battery or a rechargeable battery may be arranged at the end of a side piece of the glasses as a counterweight to the display means and possibly the image capture means. If an energy source of the data glasses, for example a battery or a rechargeable battery, has an insufficient capacity, an additional unit with additional radio interfaces may be provided, which additional unit may be worn, for example, on the belt of the maintenance person and may be connected to the data glasses via a cable.

Touch-sensitive points for operating the data glasses in the manner of a touch-sensitive screen or touchscreen may be arranged on a side piece of the data glasses, for example. Furthermore, holographically displayed user interfaces such as tiles or icons may be provided for this purpose and are perceived by the wearer of the data glasses as virtual operating elements. Such a virtual operating element may be actuated by pressing any desired surface. Graphical elements may be modified, for example, by means of swiping movements of a plurality of fingers on any desired surface. In this manner, measurement curves can be zoomed and scales can be changed. For this purpose, a camera, for example the image capture means, compares hand movements of the user with a hologram displayed in the data glasses.

Such a camera or the image capture means can also be provided for the purpose of observing eyelids of a wearer of the data glasses. The data glasses can discern which part of a hologram is currently being viewed from the wearer's eye position. An object being viewed can be selected by means of a predefined number of blinks, for example by means of one blink or two blinks. A holographic or virtual user interface may be displayed in a manner permanently visible to the wearer in his field of view, for example in reduced form in the upper left edge of his field of view. If the wearer directs his eyes to this user interface or to another object and carries out a particular blink or a particular number of blinks, the user interface or the object is increased and moves into the center of the field of view. There, sub-objects can then be selected and performed in a similar manner. It is also possible to drag objects by virtue of the wearer of the data glasses viewing an object, for example, performing a blink and then guiding the eye to another viewing area. In this case, the object is carried along with the eye. Another blink anchors the object at its new location. As an eye-guiding aid which indicates, to the wearer of the data glasses, the object at which his eye is currently aimed, a virtual laser beam can be provided on the virtual user interface. This considerably simplifies the selection of objects. In particular, in addition to the adjustment value, the measurement data transmitted to the data glasses can be graphically visualized in the display means where they can be controlled in the same manner as the objects just described.

The device may, in principle, be any desired device, for example a wind power plant or one or more arbitrary machines. The device may comprise, in particular, a rotatably mounted machine part or else two machines having respective rotatably mounted machine parts. The rotatably mounted machine parts may have respective rotational axes, the machine parts being brought relative to one another, in particular in those predefined positions in which the rotational axes are aligned flush with one another. The rotatably mounted machine parts may be axles, rollers or shafts, for example.

In order to transmit the measurement data to the data glasses, either a cable connection or a wireless connection or data transmission connection or communication connection may be provided between the data glasses and the vibration sensor, a wireless connection being preferred for transmitting data. In particular, the wireless data transmission can be carried out using a WLAN (Wireless Local Area Network) or a Bluetooth connection. If a wireless network with a low data volume is present, the data transmission can be carried out according to a specification referred to as ZigBee.

At least the steps of detecting vibrations of the device using the vibration sensor and transmitting measurement data to the data glasses are particularly preferably carried out during operation of the device. However, one or both steps of processing the measurement data by means of the data processing means and displaying the result of the processing on the display means can also additionally be carried out during operation of the device, or all method steps are carried out during operation of the device. Carrying out these steps during operation of the device allows the vibrations of the device to be detected and allows the device to be monitored during its operation permanently and in real time. Disruptions or irregularities which occur can therefore be immediately detected and eliminated even before major damage to the device can result.

The data transmission connection between the data glasses and the vibration sensor may therefore be direct or indirect, for example with a diversion via an intermediate computer. In the step of transmitting the measurement data, a direct data transmission connection can be established between the vibration sensor and the data glasses, or an indirect data transmission connection can be established between the vibration sensor and the data glasses, the data transmission connection running via at least one intermediate unit interposed between the vibration sensor and the data glasses. Accordingly, in the vibration monitoring system, a direct data transmission connection may be able to be established between the vibration sensor and the data glasses, or an indirect data transmission connection may be able to be established between the vibration sensor and the data glasses, the vibration monitoring system having at least one intermediate unit which can be connected between the vibration sensor and the data glasses and via which the data transmission connection runs. Such an intermediate unit may be worn, for example, on the belt of a user of the data glasses. Furthermore, the intermediate unit may be able to be connected to the data glasses by means of a cable connection. For example, it is possible to provide such an intermediate unit having an energy source for the data glasses or a memory which can be accessed by the data glasses for the purpose of storing or reading data.

An image capture means of the data glasses advantageously captures an image of at least one identification and the data glasses access stored data on the basis of this identification. In the simplest case, the image capture means may be a still or film camera and, in particular, a digital camera. In the viewing direction of a wearer of the data glasses, the image capture means can capture one or more images by recording them, the recorded images being able to be stored in a data memory of the data glasses or in an external memory. Images of defective parts of the device, for example, may also be captured or recorded using the image capture means for logging or documentation purposes. An angle between the image capture means and a frame of the data glasses may be advantageously adjustable in order to increase the recording range of the image capture means. If information is projected into the field of view of the user, this information can be combined with images captured by the image capture means. The display means usually advantageously has an internal projector and a prism.

Apart from data and information such as numerical values, drawings, plans, graphics, diagrams, films, images or text, other information relevant to the maintenance of the device may also be displayed in the display means in the manner of augmented reality (AR). In one advantageous embodiment of the invention, experts can also be consulted by video conference with the aid of the display means if problems occur. These experts can directly examine the situation in situ by means of the image capture means, in which case they can possibly instruct the wearer of the data glasses with regard to where he should go and look. The expert can therefore directly advise a maintenance person.

Very generally, the identification may be any desired character or a code, for example a two-dimensional code in the form of a barcode or a QR code (Quick Response). The identification may be provided on the device or the vibration sensor. The stored data may be, for example, technical data or specifications of the vibration sensor or of the device or dimensions of the device or parts of the device. After this identification has been identified and assigned by the data glasses, a maintenance person can be provided precisely with the information the person needs to maintain the device in the display means of the data glasses. In this case, the stored data may be stored either in an internal memory of the data glasses or in an external memory outside the data glasses. In the latter case, the data glasses may be advantageously set up for a wired or wireless data transmission or communication connection to at least one external unit. For example, the measured values or results obtained from the processing of the latter may be forwarded from the data glasses to an external memory via an interface of the data glasses. In addition, such an interface can be used to access an order to maintain the device which is stored in an external maintenance database and is identified on the basis of the detected identification. The Internet, in particular, makes it possible to provide relevant information in a context-based manner.

It is also advantageous if a check is carried out, on the basis of one or more captured images, in order to determine whether the vibration sensor is arranged in a prescribed manner, a result of this check being displayed in the display means. This allows possible incorrect positioning of the vibration sensor to be quickly rectified.

In practice, the locations of the relevant devices are often recorded in orders to maintain or monitor devices. In order to make it easier for maintenance persons to find the relevant device, one preferred embodiment of the invention provides for information relating to a location of the device and/or a direction display leading to the device to be displayed in the display means. For example, the display means may display a factory plan in which the current locations of the maintenance person and the device to be maintained are marked. Furthermore, an arrow may be displayed in the display means as a direction display, which arrow indicates to the maintenance person the direction in which the person has to go in order to arrive at the device to be maintained on the shortest or quickest route. In this context, the data glasses may advantageously have an interface which can be used to establish a connection to a navigation system which may be, for example, the GPS system (Global Position System) or a system for indoor navigation.

In another preferred embodiment, a schedule of a procedure to be carried out by a person is displayed in the display means. For example, it is possible to display a corresponding flowchart or a workflow for particular maintenance work, methods for aligning a rotational axis of a rotatably mounted part of the device with the rotational axis of another rotatably mounted part or other operations, from which the maintenance person can gather respective works steps to be carried out by him.

In some exemplary embodiments, control of the vibration sensor by means of the data glasses is provided. For this purpose, the data glasses transmit control commands to the vibration sensor. This makes it possible for the vibration sensor to be directly controlled by the data glasses without an additional or even external apparatus having to be provided or set up for this purpose.

The invention is explained in more detail below on the basis of a particularly preferred exemplary embodiment. In the drawings:

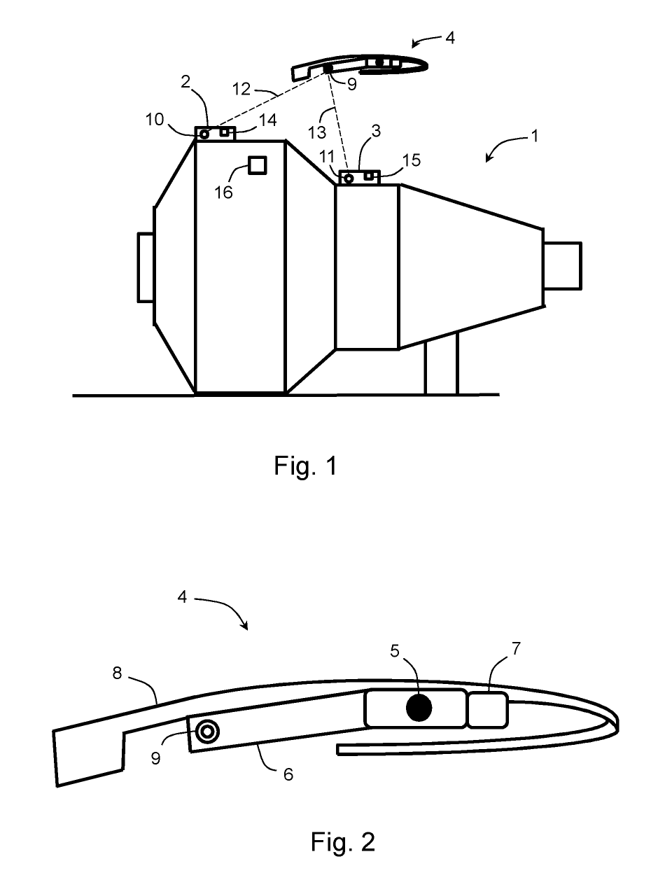

FIG. 1 shows a device to be monitored with a vibration monitoring system;

FIG. 2 shows data glasses of the vibration monitoring system;

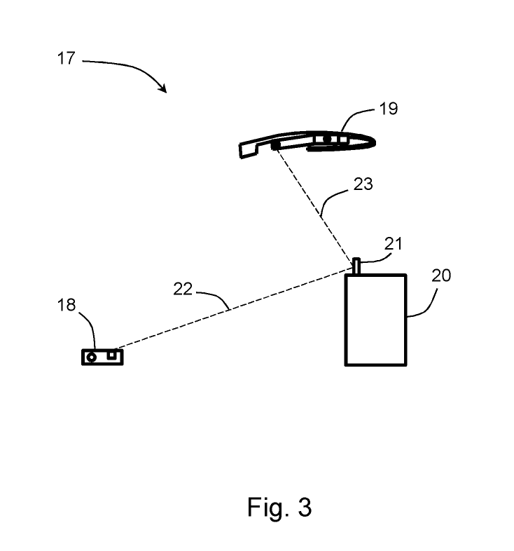

FIG. 3 shows a further vibration monitoring system.

FIG. 1 illustrates, by way of example, a device which is a machine (1). Vibrations occur during operation of the machine (1). In order to detect these vibrations, a vibration monitoring system is provided and, in the present case, comprises two vibration sensors (2) and (3) and data glasses (4). In principle, however, the vibration monitoring system may also have only one vibration sensor or may have more than two vibration sensors. Very generally, the vibration monitoring system may have an arbitrary number of vibration sensors. In particular, the vibration monitoring system may also have two or more sets of data glasses.

FIG. 2 shows the data glasses (4) in an enlarged view. Like known data glasses, the data glasses (4) of the vibration monitoring system also have a camera (5) as image capture means, a processor (6) as data processing means and a head-up display or HUD (7) as display means. In this case, the HUD (7) is arranged in such a manner that it is positioned in front of an eye of a wearer of the data glasses (4). In principle, two HUDs may also be simultaneously provided for the left eye and the right eye. The camera (5) is arranged beside the HUD (7) toward the ear of the wearer of the data glasses (4), whereas the processor (6) is in a side piece (8) adjacent thereto. An interface (9) is also provided and can be used to establish a wireless data transmission connection to the data glasses (4).

Both vibration sensors (2) and (3) likewise have interfaces (10) and (11) which can be used to establish a wireless data transmission connection to the vibration sensors (2) and (3). More specifically, the vibration sensor (2) is provided with the interface (10) and the vibration sensor (3) is provided with the interface (11). The interface (10) of the vibration sensor (2) and the interface (9) of the data glasses (4) can be used to establish a wireless data transmission connection (12), depicted using dashed lines in FIG. 1, between the vibration sensor (2) and the data glasses (4). Accordingly, the interface (11) of the vibration sensor (3) and the interface (9) of the data glasses (4) can be used to establish a wireless data transmission connection (13), depicted using dashed lines in FIG. 1, between the vibration sensor (3) and the data glasses (4).

Both vibration sensors (2) and (3) are also provided with identifications (14) and (15), to be precise the vibration sensor (2) is identified with the identification (14) and the vibration sensor (3) is identified with the identification (15). A further identification (16) is fitted to the machine (1).

In order to detect or monitor vibrations of the machine (1), the vibration sensors (2) and (3) are initially fitted to the machine (1) at positions suitable for this purpose. These positions can be determined using the data glasses (4).

For this purpose, a user of the data glasses (4) uses the camera (5) of the latter to record an image of the identification (16) fitted to the machine (1). This image is processed by the processor (6) of the data glasses (4) and the machine (1) is identified on the basis of the identification (16).

It is now possible to access stored technical specifications or data relating to this machine (1), which can be stored in an internal memory of the data glasses (4) or in an external memory. If said data are stored in an external memory or an external database, the data glasses (4) may have a corresponding interface to a network in order to access the memory or the database, which network connects the data glasses (4) to the respective memory system, for example a LAN (Local Area Network), an intranet or the Internet. The interface (9) described above can be set up for all of these purposes, in particular. After a data transmission connection has been established to the external memory via the interface (9), the data glasses (4) retrieve the data there.

If said data are available to the processor (6), respective positions which result from said data and at which the vibration sensors (2) and (3) should be arranged on the machine (1) are then displayed in the HUD (7) so that the user wearing the data glasses (4) can arrange the vibration sensors (2) and (3) at the correct positions without errors and without a large amount of time.

In order to check whether the vibration sensors (2) and (3) have been correctly fitted and fixed to the machine (1), an image of the vibration sensors (2) and (3) and, in particular, of their identifications (14) and (15) and their arrangement on the machine (1) can be recorded using the camera (5) and can be evaluated by the processor (6). On the basis of the identifications (14) and (15), it is possible for the processor (6), in particular, to distinguish the individual vibration sensors (2) and (3) from one another. The result of this evaluation is displayed to the user in the HUD (7), with the result that he can immediately correct the position of the vibration sensors (2) and (3) if necessary.

After the vibration sensors (2) and (3) have been arranged on the machine (1), they can start to detect vibrations of the machine (1). In this case, the vibration sensors (2) and (3) generate measurement data which represent the detected vibrations.

Measurement data generated by the vibration sensor (2) are transmitted to the data glasses (4) via the data transmission connection (12) set up between the interface (10) of the vibration sensor (2) and the interface (9) of the data glasses (4). Accordingly, measurement data generated by the vibration sensor (3) are transmitted to the data glasses (4) via the data transmission connection (13) set up between the interface (11) of the vibration sensor (3) and the interface (9) of the data glasses (4). Very generally, measurement data from one of the vibration sensors (2) or (3) can be transmitted to the data glasses (4) in sync or intermittently with measurement data from the respective other vibration sensor (2) or (3). In this case, the measurement data can be transmitted during operation of the machine (1), in order to ensure monitoring of the machine (1) in real time, or only after operation of the machine (1) has ended in order to subsequently analyze its operation.

It is also possible for the data glasses (4) to transmit control signals to the vibration sensors (2) and (3) via the data transmission connections (12) and (13). As a result, the data glasses (4) can control, for example, the start or the end of the transmission of measurement data or an operating mode of the vibration sensors (2) and (3) both in the vibration sensor (2) and in the vibration sensor (3).

The processor (6) processes the received measurement data. For example, the processor (6) can determine whether and at what times vibrations detected by the vibration sensors (2) and (3) have exceeded one or more threshold values. Alternatively, the processor (6) processes the measurement data with the aim of graphically visualizing the detected vibrations. The time dependence of amplitudes or frequencies of the detected vibrations can be displayed in corresponding diagrams.

Finally, a result of this processing is displayed in the HUD (7). This display may be, for example, a warning signal if a threshold value has been exceeded by detected vibrations. However, diagrams generated from the measurement data can also be displayed in the HUD (7). On the basis of the display in the HUD (7), a user of the data glasses (4) or an operator or maintenance person can take corresponding measures for regulating the operation of the machine (1) if necessary.

Both before and during the detection of vibrations by the vibration sensors (2) and (3), their transmission to the data glasses (4), processing by the processor (6) and display of the result of the processing in the HUD (7) or afterward, a schedule or workflow of an operation to be carried out by the user can be displayed to the user in the HUD (7) in order to inform the user at any time of work steps to be subsequently performed. For example, it is possible to display a workflow of a maintenance process to be carried out by the user if the detected vibrations have certain properties and exceed a threshold value, for example. However, it is also possible to visualize schedules of operations to be performed during regular operation of the machine (1) in the HUD (7).

FIG. 3 shows a further embodiment of a vibration monitoring system (17). Like the vibration monitoring system described above, the vibration monitoring system (17) also comprises vibration sensors (18), of which only one is shown in FIG. 3 for the sake of simplicity, and data glasses (19). The vibration monitoring system (17) additionally comprises an intermediate unit (20) having an interface (21) which can be used to establish communication connections or data transmission connections (22) and (23) to the intermediate unit (20). A data transmission connection (22) can be established between the vibration sensor (18) and the intermediate unit (20) and a data transmission connection (23) can be established between the intermediate unit (20) and the data glasses (19). The data transmission connections (22) and (23) and the interposed intermediate unit (20) can therefore be used to establish an indirect data transmission connection between the vibration sensor (18) and the data glasses (19), via which the vibration sensor (18) and the data glasses (19) can interchange data with one another without being directly connected to one another. In this case, the intermediate unit (20) may be portable. For example, the intermediate unit (20) may be able to be fastened to the belt of a user of the data glasses (19).

The intermediate unit (20) allows the functionality of the vibration monitoring system (17) to be extended. The intermediate unit (20) may have powerful processors with a wide variety of functions for processing or generating data and control commands which can be transmitted to the intermediate unit (20) via the data transmission connections (22) and (23) or which can be transmitted from the intermediate unit (20) to the vibration sensor (18) via the data transmission connection (22) and to the data glasses (19) via the data transmission connection (23). In addition, the intermediate unit (20) may have comparatively large data memories which can store data relating to devices to be monitored or maintained, for example handbooks or technical specifications, which can be accessed by the data glasses (19) via the data transmission connection (23). Such memories can also store data transmitted from the vibration sensor (18) via the data transmission connection (22) for subsequent evaluation or for documentation purposes or can buffer said data for subsequent access by the data glasses (19). Finally, the intermediate unit (20) may also have energy sources such as batteries or rechargeable batteries which supply the data glasses (19) with energy.

### LIST OF REFERENCE SYMBOLS

1. Machine
2. Vibration sensor
3. Vibration sensor
4. Data glasses
5. Camera
6. Processor
7. Head-up display
8. Side piece
9. Interface
10. Interface
11. Interface
12. Data transmission connection
13. Data transmission connection
14. Identification
15. Identification
16. Identification
17. Vibration monitoring system
18. Vibration sensor
19. Data glasses
20. Intermediate unit
21. Interface
22. Data transmission connection
23. Data transmission connection

1. A method for detecting vibrations of a device (1) with a rotatably mounted machine part, having the steps of:
a) arranging at least one vibration sensor (2, 3, 18) of a vibration monitoring system (17) on the device (1);
b) detecting vibrations of the device (1) using the vibration sensor (2, 3, 18);
c) transmitting measurement data representing the detected vibrations to data glasses (4, 19) of the vibration monitoring system (17);
d) processing the measurement data by means of a data processing means (6) of the data glasses (4, 19);
e) displaying a result of the processing on a display means (7) of the data glasses (4, 19).

2. The method as claimed in claim 1, in which at least steps b) and c) are carried out during operation of the device (1).

3. The method as claimed in claim 1, in which, in step c), a direct data transmission connection (12, 13) is established between the vibration sensor (2, 3) and the data glasses (4), or in which an indirect data transmission connection (22, 23) is established between the vibration sensor (18) and the data glasses (19), the data transmission connection (22, 23) running via at least one intermediate unit (20) interposed between the vibration sensor (18) and the data glasses (19).

4. The method as claimed in claim 1, in which an image capture means (5) of the data glasses (4, 19) captures an image of at least one identification (14, 15, 16) and the data glasses (4, 19) access stored data on the basis of this identification (14, 15, 16).

5. The method as claimed in claim 1, in which information relating to a location of the device (1) and/or a direction display leading to the device (1) is displayed in the display means (7).

6. The method as claimed in claim 1, in which a schedule of a procedure to be carried out by a person is displayed in the display means (7).

7. The method as claimed in claim 1, in which the data glasses (4, 19) transmit control commands to the vibration sensor (2, 3, 18).

8. A vibration monitoring system (17) for detecting vibrations of a device (1) with a rotatably mounted machine part, having at least one vibration sensor (2, 3, 18) and at least one set of data glasses (4, 19) having at least one data processing means (6) and at least one display means (7), a data transmission connection (12, 13, 22, 23) being able to be established between the vibration sensor (2, 3, 18) and the data glasses (4, 19).

9. The vibration monitoring system (17) as claimed in claim 8, in which a direct data transmission connection (12, 13) can be established between the vibration sensor (2, 3) and the data glasses (4), or in which an indirect data transmission connection (22, 23) can be established between the vibration sensor (18) and the data glasses (19), the vibration monitoring system (17) having at least one intermediate unit (20) which can be connected between the vibration sensor (18) and the data glasses (19) and via which the data transmission connection (22, 23) runs.

10. The vibration monitoring system (17) as claimed in claim 8, in which the data glasses (4, 19) also have at least one data memory and/or at least one spatial angle measuring means and/or at least one acceleration sensor and/or at least one nine-axis sensor and/or at least one gyroscope and/or at least one inclinometer and/or at least one compass and/or at least one touchpad and/or at least one bone-conduction loudspeaker and/or at least one interface (9), which can be used to establish a connection to a local area network and/or to the Internet and/or to a navigation system, and/or at least one USB connection and/or at least one current source and/or at least one battery and/or at least one rechargeable battery and/or at least one touch-sensitive point, and/or in which the data glasses (4, 19) are set up to manually modify or operate graphically or holographically displayed elements, and/or in which the data glasses (4, 19) can be at least partially controlled by means of blinks.
